(19) United States
(12) Patent Application Publication
(10) Pub. No.: US 2008/0000370 A1
(43) Pub. Date: Jan. 3, 2008

(54) Printing unit of a web-fed rotary press

(75) Inventor: Peer Dilling, Friedberg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/824,182

(22) Filed: Jun. 29, 2007

(30) Foreign Application Priority Data
Jul. 1, 2006 (DE) 10 2006 030 457.8

(51) Int. Cl. B41F 31/14

(52) U.S. Cl. 101/348

(57) ABSTRACT

A printing unit of a web-fed rotary press, with several printing couples, wherein each printing couple has a form cylinder, a transfer cylinder, an inking couple and preferably a dampening unit. At least one printing couple of the printing unit is positioned on each side of the printing unit, wherein on both sides of the printing unit, the inking couple and possibly the dampening unit of the printing couple or of each printing couple arranged on the respective side of the printing unit form an inking module. Each inking module of the printing unit can be moved relative to the other assemblies of the printing unit by an air cushion conveyance device.

### BACKGROUND OF THE INVENTION

1. Field of the Invention

The invention concerns a printing unit of a web-fed rotary press including at least one pair of printing couples, wherein each printing couple includes a form cylinder, a transfer cylinder, an inking couple which can be positioned next to the transfer cylinder, and possibly a dampening unit which can be positioned next to the transfer cylinder.

2. Description of the Related Art

Printing units of web-fed rotary presses, especially of newspaper presses or commercial web presses, have several printing couples. Each printing couple includes at least a transfer cylinder, a form cylinder, an inking couple, and preferably a dampening unit. Printing couples without a dampening unit are also known. In addition, printing units of this type can have impression cylinders, such that an impression cylinder can interact with one or more transfer cylinders of different printing couples. In addition to printing units that contain impression cylinders of this type, printing units are also known that do not have impression cylinders, and in printing units of this type without impression cylinders, the transfer cylinders of two printing couples roll on each other. Transfer cylinders are also known as blanket cylinders, and form cylinders are also known as plate cylinders. The form cylinders or plate cylinders carry printing forms.

Printing units of web-fed rotary presses are becoming more and more compact, i.e., they are being designed with smaller dimensions. This reduces the installation space available in the printing units of a printing press, i.e., the space available for the positioning or installation of the inking couples and dampening units. Furthermore, access to the cylinders, namely, the form cylinders and transfer cylinders, is more difficult in printing units with compact designs.

To produce a compact design of printing units and at the same time guarantee good access to the cylinders of the printing couples of a printing unit, it has already been proposed in U.S. Pat. No. 6,684,775 that the inking couple and the dampening unit of printing couples of a printing unit be moved relative to the cylinders of the printing couples, specifically, in a direction that runs perpendicularly to the axial direction of the cylinders of the printing couples. EP 0 638 419 B1 describes a printing unit of a web-fed rotary press, in which the inking couples and dampening units are combined into modular units, which are installed above or below the printing couples and can be moved in the axial direction of the cylinders of the printing couples. The inking couples and dampening units are moved by means of rail-mounted or roller-mounted conveyance devices, which, on the one hand, always predetermine a fixed conveyance direction and, on the other hand, complicate the mechanical design of the web-fed rotary press and thus cause higher costs.

### SUMMARY OF THE INVENTION

Proceeding from this prior art, an object of the present invention is to create a novel printing unit of a web-fed rotary press, which, on the one hand, has a compact design with good access to the cylinders and, on the other hand, has a simple mechanical design.

In accordance with the invention, each inking module of the printing unit can be moved relative to the other assemblies of the printing unit by an air cushion conveyance device.

In accordance with the present invention, it is proposed for the first time that, in a printing unit of a web-fed rotary press, inking couples and possibly dampening units of printing couples of the printing unit be moved or conveyed by an air cushion conveyance device.

With the use of an air cushion conveyance device for moving the inking couples and possibly the dampening units, only a slight change in the design of the substructure and superstructure of a web-fed rotary press is necessary, so that it is possible to ensure a web-fed rotary press design that is much simpler and thus more cost-effective that rail-mounted or roller-mounted conveyance devices. Furthermore, air cushion conveyance devices do not predetermine a fixed direction of conveyance, but rather the inking couples and dampening units can be moved into almost any desired position relative to the printing unit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic representation of a section of a web-fed rotary press in the area of two printing units of the invention arranged one above the other; and

FIG. 2 is a schematic top view of the installation of FIG. 1.

### DETAILED DESCRIPTION OF THE PRESENTLY PREFERRED EMBODIMENTS

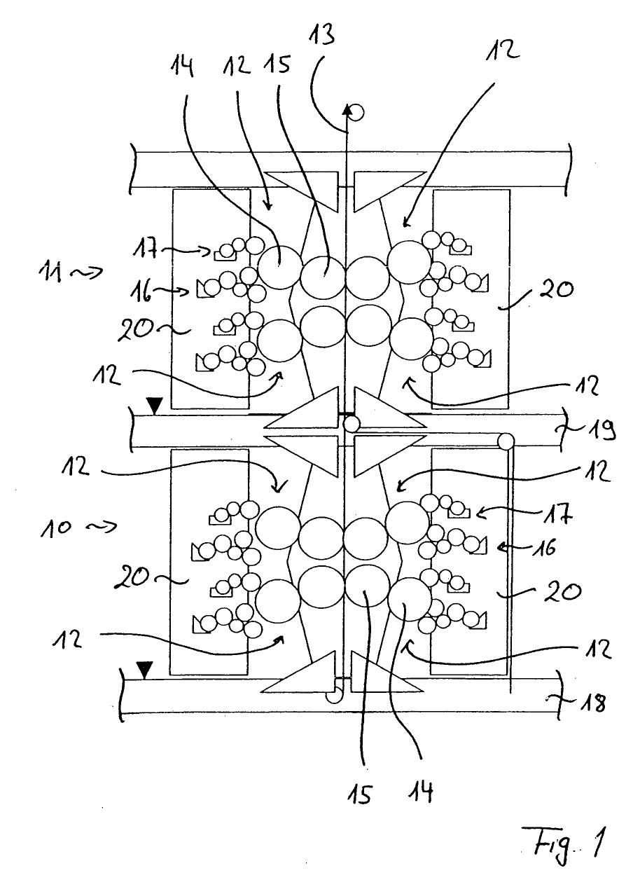

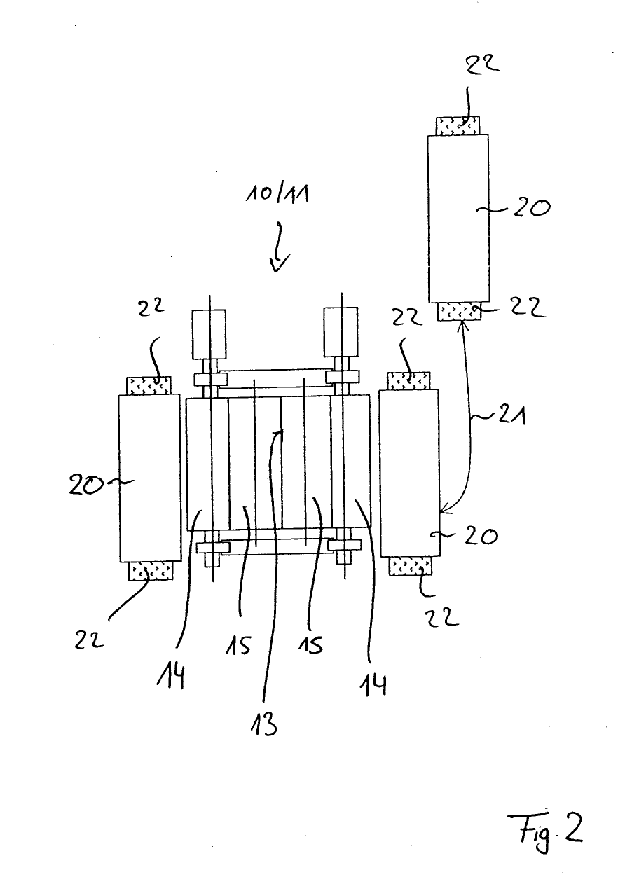

FIGS. 1 and 2 show a section of a web-fed rotary press in the area of two printing units 10, 11 of the invention arranged vertically one above the other, which together constitute a printing tower. In the illustrated embodiment, each of the printing units 10, 11 has four printing couples 12 for printing a web of printing material 13, which is conveyed vertically through the printing units 10, 11.

Each of the printing couples 12 has a form cylinder 14, a transfer cylinder 15, an inking couple 16, and a dampening unit 17. Sets of two transfer cylinders 15 of printing couples 12 positioned on different sides of the printing units 10, 11 roll on each other and print the printing material 13 on both sides. The printing units 10, 11 illustrated in FIG. 1 are thus 8-cylinder printing units.

Each of the printing units 10, 11 is mounted on a mounting level 18, 19, respectively, which is also referred to as a gallery level of the web-fed rotary press. The inking couples 16 and dampening units 17 of the printing couples 12 of the respective printing units 10, 11 are arranged on opposite sides of the printing units 10, 11 and form individual inking modules 20, so that, in the illustrated embodiment, each printing unit 10, 11 has two inking modules 20, each with two inking couples 16 and two dampening units 17.

In accordance with the present invention, each inking module 20 of each printing unit 10, 11 can be moved relative to the other assemblies of the printing unit, especially relative to the cylinders 14, 15 of the printing unit, specifically, by means of an air cushion conveyance device. With the use of an air cushion conveyance device, an inking module 20 can be lifted from a mounting level 18, 19 on which it stands in order to move it in its raised position relative to the other assemblies of the printing unit 10, 11.

With the use of an air cushion conveyance device, an inking module 20 can be moved in any desired direction between two positions, as indicated by the arrow 21. To realize a change in direction, virtually no additional expenditure of energy is necessary, since air cushion conveyance devices operate practically without friction.

Preferably, an air cushion conveyance device is rigidly connected with each inking module 20. In the embodiment illustrated here, an air cushion conveyance device comprises at least two air cushion modules 22, with one air cushion module 22 acting on each of two opposite sides of an inking module 20. Then, if the air cushion modules assigned to one inking module 20 are subjected to different or unequal loads, this can be compensated by individual pressure regulation of the air cushion modules. The number of air cushion modules 22 assigned to an inking module 20 depends on the weight of the inking module and on the load capacity of the air cushion modules and can be chosen as desired.

In contrast to the illustrated embodiment, it is also possible to convey each inking module with a flexible air cushion conveyance device, e.g., with an air cushion transfer carriage. In this case, there is no fixed assignment of an air cushion conveyance device to the inking modules, but rather, when required, an air cushion transfer carriage is pushed under the inking module to be conveyed in order to lift the inking module from the mounting level.

The present invention proposes that inking modules of a printing unit be moved or conveyed by air cushion conveyance devices. These air cushion conveyance devices can lift an inking unit by about 0.5 mm from the mounting level and then move the inking unit with an extremely small expenditure of energy. When an inking module is moved into an operating position in the printing unit by an air cushion conveyance device, stops are present in the printing unit which exactly determine the operating position. The operating position can be secured against dynamic influences by clamping elements. Only the operating position of the inking modules in the printing unit must be exactly maintained to guarantee high printing quality. However, no other positions of the inking modules relative to the given printing unit are fixed, nor do any other positions need to be reached exactly.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing unit printing unit of a web-fed rotary press, the printing unit comprising at least one pair of printing couples, each said printing couple comprising:
a form cylinder;
a transfer cylinder;
an inking couple which can be positioned next to said transfer cylinder, said inking couple forming part of an inking module; and
an air cushion conveyance device which supports the inking module on a cushion of air and conveys the inking module relative to the transfer cylinder.

2. The printing unit of claim 1 further comprising a mounting level for each pair of inking modules, each said air cushion conveyance device forming an air cushion between said mounting level and a respective said inking module.

3. The printing unit of claim a wherein each said air cushion conveyance device is fixed to a respective said inking module.

4. The printing unit of claim 3 wherein each said air cushion conveyance device comprises at least two air cushion modules which can be individually regulated to produce unequal air pressures for supporting unequal loads.

5. The printing unit of claim 1 wherein at least one said air cushion conveyance device is a flexible air cushion device that can be moved under a respective said inking module to provide a cushion of air for supporting the inking module.

6. The printing unit of claim 5 wherein the flexible air cushion conveyance device is an air cushion transfer carriage.

7. The printing unit of claim 6 further comprising an air cushion track having flexible travel paths which are followed by the flexible air cushion device to an impression throw-on position, an impression throw-off position, a set-up position, a maintenance position, and a service position.

8. The printing unit of claim 1 wherein each said inking module further comprises a dampening unit which can be positioned next to a respective said transfer cylinder.

9. The printing unit of claim 1 wherein each said inking module comprises two of said inking units.
